(19) United States
(12) Patent Application Publication
(10) Pub. No.: US 2006/0173803 A1
(43) Pub. Date: Aug. 3, 2006

(54) Method and system for associating specific files with different applications

(76) Inventor: Robert P. Morris, Raleigh, NC (US)

Correspondence Address: SCENERA RESEARCH, LLC, 111 Corning Road, Suite 220, Cary, NC, 27511, US

(21) Appl. No.: 11/046,118

(22) Filed: Jan. 28, 2005

(51) Int. Cl. G06F 17/30; H04N 5/225

(52) U.S. Cl. 707/1; 348/207.1

(57) ABSTRACT

A method and system for associating specific files with different applications. The method includes receiving a selection of at least one application; receiving a selection of at least one specific file; and associating the at least one specific file with the at least one application such that when the application is launched, the specific file is automatically made available to the application.

### FIELD OF THE INVENTION

The present invention relates to image processing, and more particularly to a method and system for associating specific files with different applications.

### BACKGROUND OF THE INVENTION

Images are used by numerous applications for web design, word processing, desktop publishing, presentation software, email, etc. Images are also used by many imaging specific applications such as image organizers, image editors, etc.

Images are typically captured by a camera, then stored on a flash card, and then downloaded onto a hard drive on a PC. When images are downloaded from a camera to a PC, the images are typically copied manually to a directory, which can be tedious. Some conventional applications automatically download images from a camera to a PC. A problem with such conventional applications is that folder names and file names are automatically created, and these names are typically not meaningful. For example, the file names and directory names are typically numbered sequentially. The directory name may include a camera vendor's ID. Such a naming convention makes it tedious for a user to find a particular image.

Some conventional applications such as photo organizing software may be registered to detect images on newly inserted removable media (e.g. flash card). Such applications automatically take actions on images, immediately as they arrive at the PC. A problem with such conventional applications is that every image is associated with the application and the associations are fixed. A second problem is that not all of the images on a removable media are necessarily intended for such applications. Consequently, images found by such an application may not be compatible with the application or may not be useful to a user with the application. Also, because batch files for the automatic associations are immediately executed, and the user has no choice as to when images are associated and how images are associated.

Some conventional applications scan storage to detect files with image types that the applications are capable of working with. A problem with such conventional applications is that they typically scan the “current working” directory. A problem with such conventional applications is that the user must take steps to search for the images to ensure that the current working directory contains the images to be processed.

Images can also be uploaded onto a website. Images uploaded to websites are typically copied to a temporary holding area (e.g. a clipboard). Conventional applications that run from such websites have similar problems to conventional applications that run on PCs. For example, conventional applications on websites may have automated actions, but such applications cannot distinguish between images that are to be associated with automated online features and features that require user interaction.

Generally, when a user opens an application and wishes to process an image, the user must first find the image typically by browsing the file system or by searching. Then the user then typically uses the application to select the image.

Accordingly, what is needed is a more efficient and reliable method and system for associating specific files with different applications. The present invention addresses such a need.

### SUMMARY OF THE INVENTION

The present invention provides a method and system for associating specific files with different applications. The method includes receiving a selection of at least one application; receiving a selection of at least one specific file; and associating the at least one specific file with the at least one application such that when the application is launched, the specific file is automatically made available to the application.

According to the method and system described herein, the present invention enables a user to associate particular files (e.g. images) with different applications, instead of the conventional method of associating an application with a particular file type.

### BRIEF DESCRIPTION OF THE DRAWINGS

FIG. 1 is a block diagram of an image capture device (ICD) and a host system in accordance with the present invention.

FIG. 2 is a simplified block diagram of the ICD and the host system of FIG. 1 in accordance with the present invention.

FIG. 3 is a flow chart showing a method for associating specific files with different applications in accordance with the present invention.

FIG. 4 is a flow chart showing a method for associating specific files with different applications in accordance with another embodiment of the present invention.

FIG. 5 is a flow chart showing a method for storing images after they have been associated with applications in accordance with the present invention.

FIG. 6 is a flow chart showing a method for accessing images after they have been stored in an image location in accordance with the present invention.

FIG. 7 is a flow chart showing a method for accessing images after they have been stored in an image location in accordance with another embodiment of the present invention.

FIG. 8 is a flow chart showing a method for accessing images after they have been stored in an image location in accordance with the present invention.

### DETAILED DESCRIPTION OF THE INVENTION

The present invention relates to image processing, and more particularly to a method and system for associating specific files with different applications. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiment shown, but is to be accorded the widest scope consistent with the principles and features described herein.

The present invention provides a method for associating images with specific applications. The present invention extends the notion of file associations beyond associating an application with a particular file type to associating a specific file with one or more applications. In a preferred embodiment, each image is automatically associated with one or more applications as each image is captured on an image capture device. In another embodiment, each image is associated with one or more applications after each image is captured. Each image is then stored in one or more queues or directories, where each queue and directory is uniquely associated with a specific application. As a result, an image can be conveniently associated with one or more applications, and the image can be conveniently accessed for processing when using the one or more associated applications.

Although the present invention will be described in terms of a preferred embodiment where files are digital images captured by an image capture device, the present invention may apply to other types of files, and still remain within the spirit and scope of the present invention.

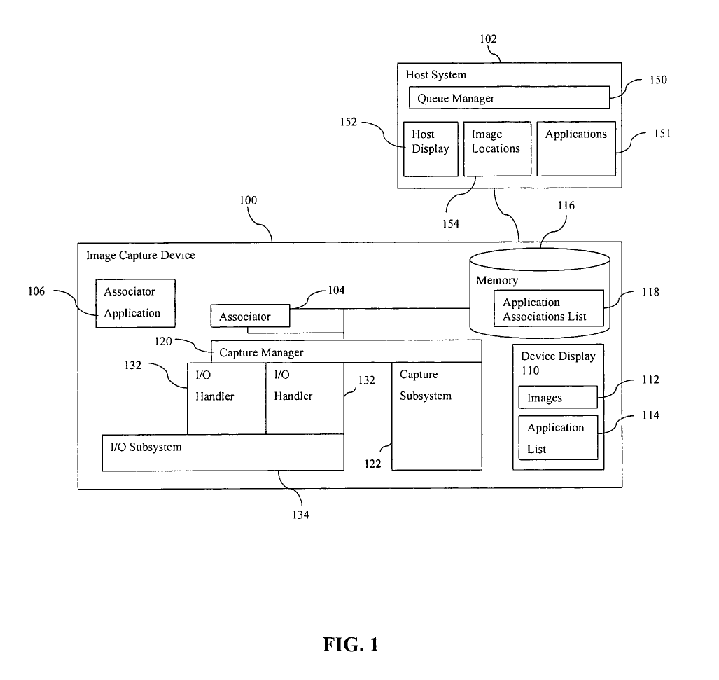

FIG. 1 is a block diagram of a system for associating specific files with different applications. In a preferred embodiment, the system includes an image capture device (ICD) 100, which is preferably a digital camera, and a host system 102, which is preferably a separate computer. Alternatively, the present invention can be implemented with a camera phone, where the ICD 100 and the host system 102 are combined in the same unit.

The ICD 100 includes an associator 104, an associator application 106, a display 110 for displaying images 112 and a list 114 of applications, a memory 116, a capture manager 120, a capture subsystem 122, input/output (I/O) handlers 130 and 132, and an I/O subsystem 134. The host system 102 includes a queue manager 150, one or more software applications 151, image locations 154 corresponding to each application 151, and a host display 152 capable of displaying images and the image locations 154.

In operation, the capture manager 120 manages the capture subsystem 122, which includes capturing images and sending the captured images 112 to the memory 116. Once the images 112 are stored in the memory 116, the images 112 can be viewed on the display 110. The capture manager 120 notifies the associator 104 of each newly captured image 112. The associator 104 invokes the associator application 106 that enables a user to associate individual images and/or groups of images with one or more applications from a displayed list 114 of applications. Preferably, the applications on the applications list 114 correspond to the applications 151 present on the host system 102.

The host system 102 maintains a unique image location 154 for the respective applications 151 loaded thereon. When the images 112 are transferred from the ICD 100 to the host system 102, the queue manager 150 receives the images 112 and routes the images 112 to the image location 154 corresponding to the application 151 to which the image 112 was associated with by the user. When an associated application 151 is subsequently run on the host system 102, the images 112 in corresponding image location 154 are readily available for use by the application.

In a preferred embodiment, the user of the ICD 100 can create different groups of images by pressing a group button or by selecting such a command on a menu. Whenever a new image group is created, the ICD 100 automatically names the group, preferably using the start and end day and the time of the group. The image groups can alternatively be given meaningful names by the user for future reference. For example, the user may form one group of images from a series of images taken at a soccer game, and for a second group of images from a series of images taken at a celebration party. According to the preferred embodiment of the present invention, the user may designate the images in the first group to be associated with one or more applications, and then designate the images in the second group to be associated with the same or other applications. When the images 112 are subsequently transferred to the host system 102 the images from the first group are placed in the image location 154 corresponding to the first application, and places the images from the second group into the image location 154 corresponding to the other application. When the first or second applications are invoked, the user's images are readily available for use by the application.

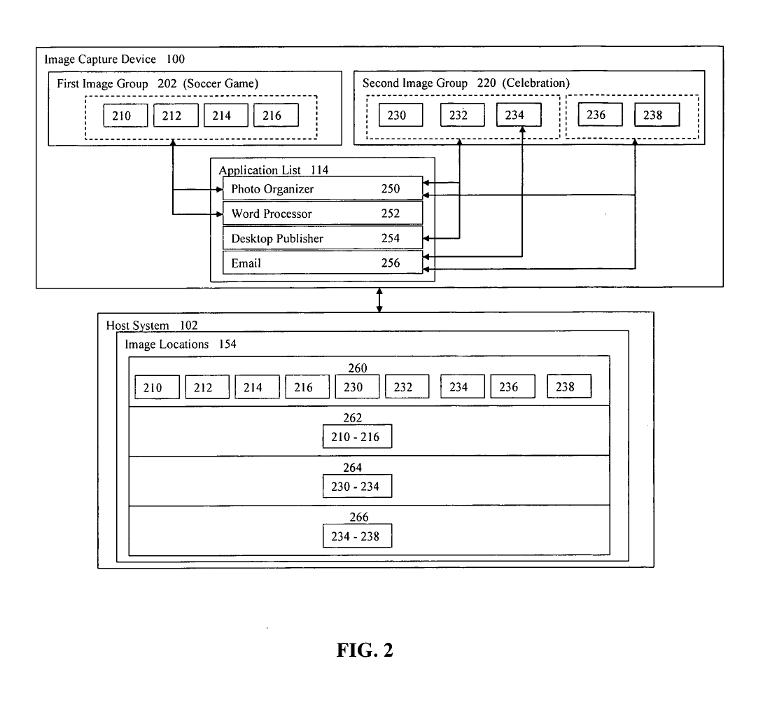

FIG. 2 is a simplified block diagram showing the contents of the ICD 100 and the host system 102 based on the example above. For ease of illustration, the hardware components shown in FIG. 1 are omitted in FIG. 2. The ICD 100 includes a first image group 202, which includes the series of images 210-216 taken at the soccer game, and a second image group 220, which includes the series of images 230-238 taken at the subsequent victory celebration. The ICD 110 is shown displaying a list 114 of application selections 250-256, which correspond to actual software applications stored on the host system 102. The host system 102 includes image locations 260-266 for storing image files for the applications 151 corresponding to the application selections 250-256 displayed in list 114.

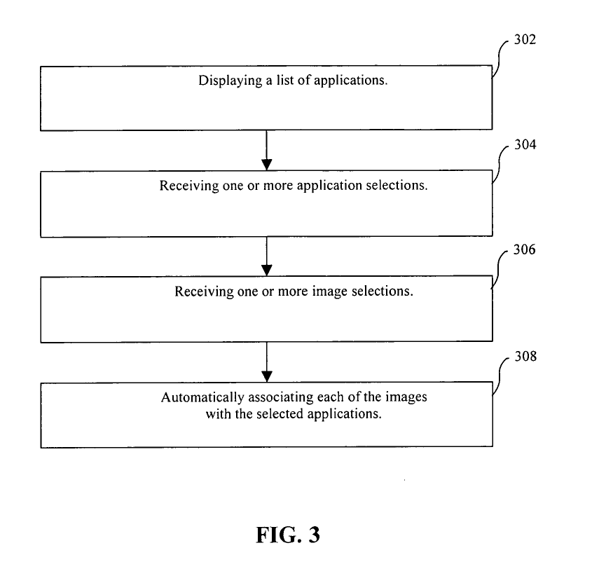

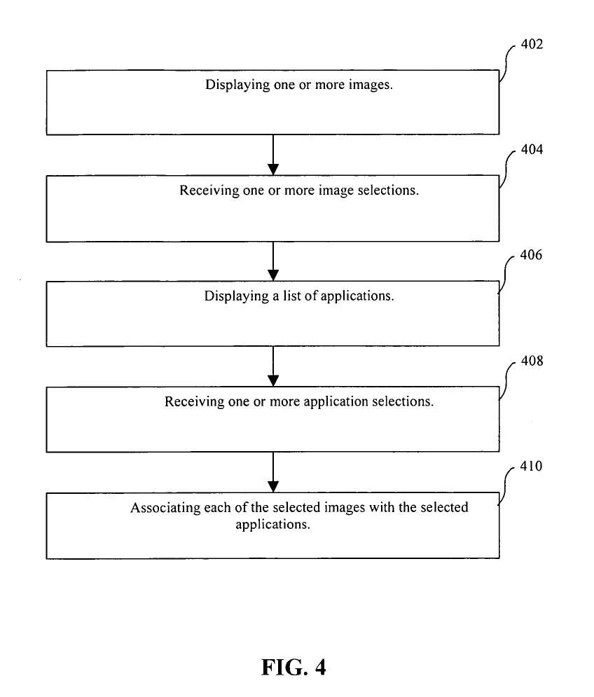

As is shown in more detail in the embodiments and examples of FIGS. 3 and 4 below, the user can view the images 210-216 from the first image group 202 taken at the soccer game and associate all of the images 210-216 with the photo organizer and word processor applications 250 and 252. The user can then view the images 230-238 from the second image group 220 taken at the celebration. The user can then associate all of the images 230-238 with the photo organizer application 250, associate three of the images 230-234 with a desktop publishing application 254, and associate three of the images 234-238 with the email application 256.

FIG. 3 is a flow chart showing a method for associating specific files with different applications in accordance with the present invention. Referring to both FIGS. 2 and 3, the process begins in block 302 when the associator application 106 displays the list 114 of applications on the ICD 100. The list 114 can originate from the host system 102 via a direct connection to the ICD 100, via an Internet connection, or via a removable media device such as a flash card. The user views the list 114 and selects one or more of the applications 250, 252, 254, and 256 from the list 114, and in block 304, the user's application selections 250 and 252 are received by the associator application 106. In the example above, the user selects the photo organizer application 250 and the word processor application 252 from the list 114. A selected application 250-256 may also include existing files previously associated with the specific applications 250-256.

In block 306, the associator application 106 receives one or more image selections. In this specific embodiment, one or more of the images 210-216 are automatically selected after each image is captured (e.g. by creating a group). The images 230-238 may also be automatically selected, but for illustrative purposes they are taken at another time and are manually selected utilizing a method described below in FIG. 4. Blocks 304 and 306 are preferably order independent, as described with respect to FIG. 4.

In block 308 of FIG. 3, the associator application automatically associates each of the selected images 210-216 with the selected applications (e.g. applications 250 and 252). In a preferred embodiment, an application ID is used to identify the application, and the application ID is associated with the selected image(s). The application ID may be an ID number or a name, such as the name of the application. The application ID of a selected application is preferably associated with the image by storing the application ID in a file or as a tag in the image's metadata, which are both collectively referred to herein as an application associations list 118. The metadata is preferably embedded in an image file, which contains the image. After the images 210-216 are associated with the applications 250 and 252, the images and the application associations list 118 are stored in the memory 116 (FIG. 1).

When the images are transferred to the host system 102, the application associations list 118 is also transferred, either in the image's metadata, or in a separate file. In the embodiment where the application associations list 118 is transmitted separately via a separate file, the file may be an XML file having links to the associated images. Alternatively, the associator application 104 may also execute an algorithm to generate a folder that is associated with a selected application. The image(s) can be copied into the folder or the folder can have pointers that reference the image. Accordingly, it should be understood that the images are not associated with the applications using operating system file types.

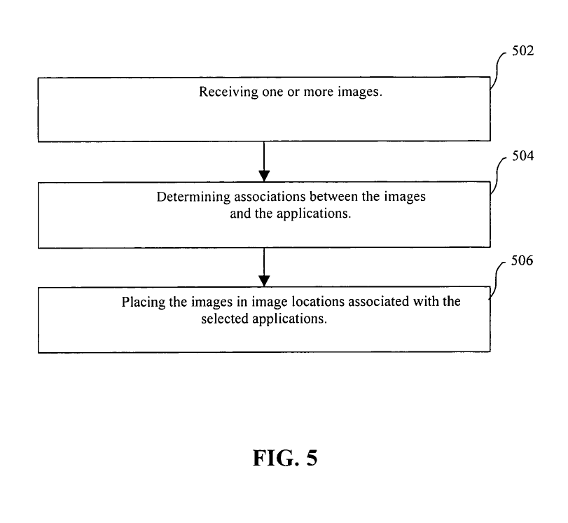

The queue manager 150 receives the images and application associations list 118 and routes the images to the image locations 154 corresponding to the applications listed in the application associations list 118, as described below with reference to FIG. 5. Accordingly, each of the images 210-216 is automatically made available for subsequent processing by the selected applications based on the application ID. For example, after the user transfers images 210-216 to the host system 102 and invokes the photo organizer application 250 on the host system 102, a window may be automatically displayed showing the availability of the images 210-216. The user may then use the photo organizer application 250 to organize the images 210-216. Likewise, when the user invokes the word processor application 252, a window may be automatically displayed showing the availability of the images 210-216, which the user may then incorporate in an article written using the word processor application 252.

According to another embodiment of the present invention, one or more images can be captured before applications are selected. FIG. 4 is a flow chart showing a method for associating specific files with different applications in accordance with another embodiment of the present invention. In this specific embodiment, referring to FIGS. 2 and 4 together, the process begins in block 402 where one or more images 230-234 are displayed on the ICD 100. In this specific example, the images 210-216 and 230-238 are viewed and the images 230-234 are selected by the user. The user may also select some of the images 210-216 from the first image group 202, where the images 210-216 have already been associated with applications, and/or the images 236 and 238, and/or images from any other image group. But for ease of illustration, only the images 230-234 are selected in this specific example.

In block 404, one or more image selections are received by the associator application 106. In block 406, the associator application 106 displays the list 114 of applications on the ICD 100. The user then views the list 114 and selects one or more applications. In this specific example, the applications 250 and 254 are selected. As can be seen from this example and the example above with FIG. 3, an application 250 can be selected during different associating processes. In block 408, one or more application selections are received by the associator application 106. In block 410, the associator application 106 automatically associates each of the selected images 230-238 with the selected applications (e.g. applications 250, 254, and 256) using the application associations list 118, as described above. After the images 230-238 are associated with the applications 250, 254, and 256, the images 230-238 are then stored in memory along with the application associations list 118. As with the blocks of other embodiments described herein, the blocks 402-410 are not order dependent. For example, blocks 406 and 408 can occur before blocks 402 and 404.

The method of FIG. 4 can be repeated for different combinations of images and applications. For example, the user can repeat blocks 402-408 to associate the images 236 and 238 with the photo organizer application 250. The user can again repeat blocks 402-408 to associate the images 234-238 with the photo organizing application 250 and the email application 256.

In an alternative embodiment, unmarked images (i.e. images that have not yet been associated with an application) may be first downloaded to the host system 102 before being associated with an application. The queue manager 150 (FIG. 1) on the host system 102 recognizes unmarked images when they are downloaded to the host system 102. The queue manager 150 can then by default automatically associate the unmarked images with a default application using file-IDs and/or can notify the user that some images have not been associated with an application.

As can be seen, a benefit of the present invention is that the user chooses when to associate images with an application and chooses which specific images to associate with which applications, rather than only associating all images of a specific file type to a specific application.

In a further embodiment of the present invention, security data can be associated with each image on the ICD 100. The security data provides permissions with respect to the images so that images are properly protected on the host system 102. For example, the security data can ensure that intended users can access an image with an intended application while restricting unintended users from accessing it with unintended applications.

FIG. 5 is a flow chart showing a method for storing images after they have been associated with applications in accordance with the present invention. Referring to FIGS. 2 and 5 together, the process begins in block 502 where one or more images 210-216 and 230-238 are received at the host system 102. The host system 102 can receive the images 210-216 and 230-238 via a direct connection to the ICD 100, via the Internet, or via a removable media device such as a flash memory card. In block 504, associations between the images and the applications are determined. The associations can be determined from tags in metadata or from other accompanying data such as folder names. In block 506, the images are placed in image locations 260-266 associated with the selected applications, where each application has a designated image location.

In a preferred embodiment, the image locations 260-266 are application queues (also referred to as “shoe boxes”). In an alternative embodiment, the image locations 260-266 are folders.

When queues are utilized, the software for the applications is modified in order to better integrate respective queues during operation. A benefit of using queues for the image locations 260-266 is that a queue can be readily available once its associated application is launched. For example, if a user downloads images from the ICD 100 to the host system 102, the application associated with the images will automatically import the images from respective queues. For example, continuing with the examples described above, the photo organizer application 250 will import two groups of images 210-216 and 230-238 from the photo organizer queue 260. Similarly, the word processor application 252 will import one group of images 210-216 from the word processor queue 262. Similarly, the desktop publisher application 254 will import one group of images 230-234 from the desktop publisher queue 264. Similarly, the email application 256 will import one group of images 234-238 from the email queue 266.

When folders are utilized in lieu of queues, no modifications to the software for the applications are necessary. A directory structure is created with a naming convention that corresponds to the applications. As such, after images are associated with applications, the images are sent to respective folders associated with respective selected applications. Directory structures are standard on most operating systems. As such, images are put in folders of the directory structure. Shortcuts to such folders can be automatically placed on the desktop with icons. Opening a shortcut can open a folder showing where each of the images is by utilizing the format of a context menu where each image has an entry for the application.

Generally, because images can be associated with multiple applications, the images are copied into the image locations (e.g. queues or folders) of their respective applications. Alternatively, images can be stored in one image location with pointers to respective applications.

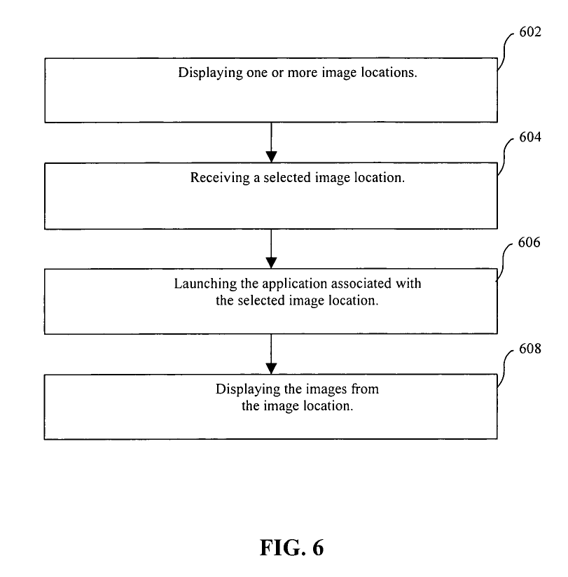

FIG. 6 is a flow chart showing a method for accessing images after they have been stored in an image location in accordance with the present invention. Referring to FIGS. 2 and 6 together, the process begins in block 602 where one or more image locations 260-266 are displayed on the host system 102 to the user. The user views the image locations 260-266 and selects an image location 260-266. As stated above, the image locations 260-266 can be queues or folders. In block 604, a selected image location (e.g. image location 260) is received. In block 606, the application (e.g. the photo organizer application 250) associated with the selected image location is launched. In block 608, the images (e.g. 210-215 and 230-238) from the image location are displayed to the user in an application workspace or alternatively in a nearby associated work space (e.g. a second window).

In an alternative embodiment, an application is launched when the user selects a specific file (e.g., an image). If there is only one application associated with the specific file, it is launched and the specific file is automatically made available to the application. If there is more than one application associated with the specific file, the user is given the opportunity to select one of the associated applications to open in response to the selecting of the specific file.

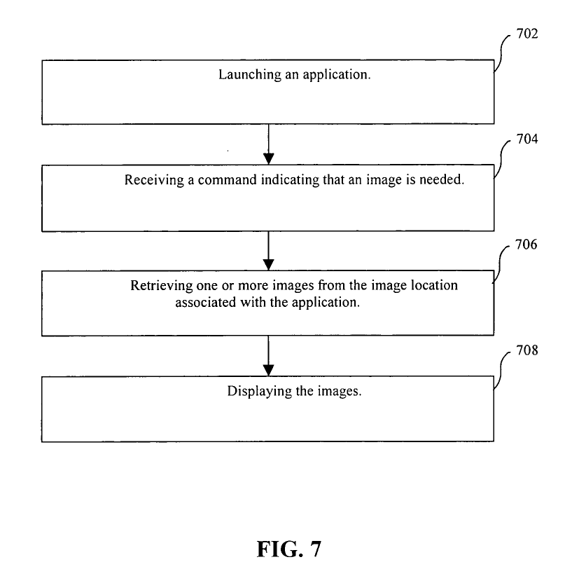

FIG. 7 is a flow chart showing a method for accessing images after they have been stored in an image location in accordance with another embodiment of the present invention. Referring to FIGS. 2 and 7 together, the process begins in block 702 where an application is launched. In block 704, a command indicating that an image is needed is received from the user. The user can initiate the command by pressing a button or by selecting the command from a menu. In block 706, one or more images are retrieved from the image location associated with the application. In block 708, the images are displayed to the user. The images may be displayed as thumbnails or items in a file menu. The user can then select images for processing.

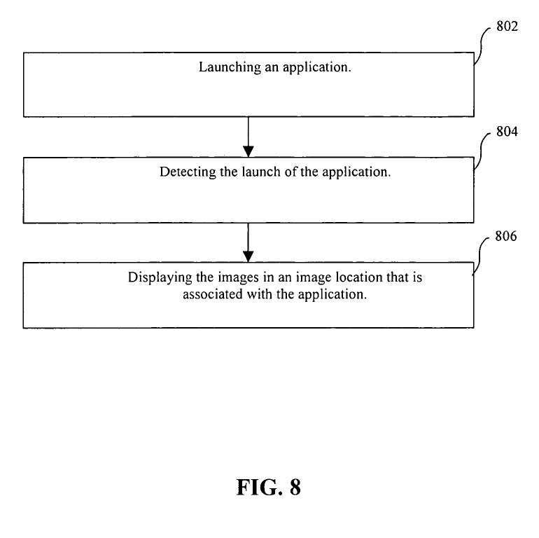

FIG. 8 is a flow chart showing a method for accessing images after they have been stored in an image location in accordance with the present invention. Referring to FIGS. 2 and 8 together, the process begins in block 802 where an application is launched. In block 804, the launch of the application is detected. In block 806, the images are displayed in the image location associated with the application. The image location may be in a window separate from the working window of the application. The user can then drag and drop images between the windows.

According to the system and method disclosed herein, the present invention provides numerous benefits. For example, an image can be conveniently associated with one or more applications and the image can be conveniently accessed for processing when using the one or more associated applications.

A method and system for associating specific files with different applications has been disclosed. The present invention has been described in accordance with the embodiments shown. One of ordinary skill in the art will readily recognize that there could be variations to the embodiments, and that any variations would be within the spirit and scope of the present invention. For example, the present invention can be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

We claim:

1. A method for associating a specific file with different applications, the method comprising:
receiving a selection of at least one application;
receiving a selection of at least one specific file; and
associating the at least one specific file with the at least one application such that when the application is launched, the specific file is automatically made available to the application.

2. The method of claim 1 wherein the associating comprises associating the at least one specific file with the at least one application by associating an application ID that identifies the application with the specific file.

3. The method of claim 1 further comprising storing the at least one specific file in at least one file location that is associated with an application.

4. The method of claim 3 wherein the at least one file location is an application queue.

5. The method of claim 3 wherein the at least one file location is a folder.

6. The method of claim 3 wherein the storing comprises:
receiving the at least one specific file;
determining an association between the at least one specific file and the at least one application; and
storing the at least one specific file in the at least one file location based on the association.

7. The method of claim 3 further comprising allowing a user to access the at least one specific file.

8. The method of claim 7 wherein the accessing comprises:
launching the at least one application;
receiving a command indicating that a specific file is needed;
retrieving the at least one specific file; and
displaying the at least one specific file.

9. The method of claim 7 wherein the accessing comprises:
launching the at least one application;
detecting that the at one application has been launched;
retrieving the at least one specific file from the file location; and
displaying the at least one specific file in the at least one file location.

10. The method of claim 7 wherein the accessing comprises:
displaying the at least one file location;
receiving a user selection of the at least one file location;
launching the at least one application associated with the least one file location; and
displaying the at least one specific file.

11. The method of claim 1 wherein the receiving selections and the associating occur on an image capture device that captures images.

12. The method of claim 11 wherein the receiving a selection of at least one specific file further comprises:
capturing the at least one image; and
automatically selecting the at least one image.

13. The method of claim 11 wherein the receiving a selection of at least one specific file further comprises:
capturing the at least one image; and
displaying the at least one image so that a user can select the at least one image.

14. The method of claim 1 wherein the receiving a selection of at least one specific file further comprises displaying the at least one application so that a user can select the at least one application.

15. The method of claim 1 wherein the associating further comprises generating metadata that identifies the at least one application.

16. The method of claim 1 wherein the associating further comprises generating security data, wherein the security data provides permissions with respect to the at least one specific file.

17. The method of claim 1 wherein the receiving selections and the associating occur on a host system.

18. The method of claim 17 further comprising automatically associating the at least one specific file with a default application, if the at least one specific file has not already been associated with an application.

19. The method of claim 18 further comprising notifying the user that the at least one specific file has not been associated with an application.

20. A method for associating a specific file with different applications, the method comprising:
receiving a selection of at least one application;
receiving a selection of at least one specific file; and
associating the at least one specific file with the at least one application by associating an application ID that identifies the application with the specific file.

21. The method of claim 20, comprising:
launching the at least one application in response to a second selection of the at least one specific file, wherein the specific file is automatically made available to the launched application.

22. The method of claim 21, comprising:
allowing the selection of one of a plurality of applications associated with the at least one specific file to launch in response to the second selection of the specific file, wherein the specific file is automatically made available to the launched application.

23. A method for associating a specific file with different applications, the method comprising:
receiving on a camera a first selection of at least one application;
receiving on the camera a second selection of at least one specific file;
associating the at least one specific file with the at least one application based on the first and second selections; and
uploading the at least one specific file from the camera to at least one file location on a host system, wherein the at least one specific file is uniquely associated with the at least one application such that when the application is launched, the specific file is automatically made available to the application.

24. A computer readable medium containing program instructions for associating a specific file with different applications, the program instructions which when executed by a computer system cause the computer system to execute a method comprising:
receiving a first selection of at least one application;
receiving a second selection of at least one specific file; and
associating the at least one specific file with the at least one application based on the first and second selections such that when the application is launched, the specific file is automatically made available to the application.

25. A system comprising:
a capture subsystem for capturing at least one specific file;
a memory coupled to the capture subsystem, wherein the memory stores a list of applications and the at least one specific file; and
an associator coupled to the memory, wherein the associator receives an application selection from the list of applications, and wherein the associator associates the at least one specific file to at least one application based on the application selection such that when the application is launched, the specific file is automatically made available to the application.

26. The system of claim 25 wherein the associator automatically associates specific files with the application selection as the specific files are captured.

27. The system of claim 25 further comprising a display for displaying the list of applications to a user and for displaying the at least one specific file.

28. The system of claim 25 further comprising:
a host subsystem coupled to the image capture device, the host subsystem comprising at least one file location, wherein the at least one specific file is stored in the at least one file location after the at least one specific file is associated with the at least one application.

29. A host system comprising:
a memory for storing at least one specific file and a list of applications; and an associator coupled to the memory, wherein the associator receives an application selection from the list of applications, and wherein the associator associates the at least one specific file to at least one application based on the application selection such that when the application is launched, the specific file is automatically made available to the application.
